(19) United States
(12) Patent Application Publication
(10) Pub. No.: US 2004/0148246 A1
(43) Pub. Date: Jul. 29, 2004

(54) Asset allocation optimization process

(76) Inventor: Ali Enis Uysal, New York, NY (US)

Correspondence Address: KENYON & KENYON, ONE BROADWAY, NEW YORK, NY, 10004, US

(21) Appl. No.: 10/353,739

(22) Filed: Jan. 29, 2003

(51) Int. Cl. G06F 17/60

(52) U.S. Cl. 705/37

(57) ABSTRACT

A method for optimizing an allocation of a plurality of selected assets in which a set of discrete possible outcomes for returns on each of the plurality of assets are generated, and at least one favorable trade idea is provided. A subset of the discrete outcomes are identified as winning outcomes consistent with the at least one favorable trade idea and a remaining subset of discrete outcomes are identified as losing outcomes. After further constraints are specified, an allocation of the plurality of assets is determined that optimizes an attribute of at least one of the winning and losing outcomes subject to the further constraints.

### FIELD OF THE INVENTION

The present invention relates to financial portfolio management, and in particular relates to a method for optimizing allocation of funds among a selected group of assets.

### BACKGROUND INFORMATION

Many financial institutions use mathematical models at some stage in formulating asset allocation strategies. Such mathematical models are typically used to determine an optimal allocation amongst different assets that maximizes total return and/or minimizes risk based upon input information and selected constraints. Conventional asset allocation techniques generally require as inputs both the expected returns on each asset and each asset's covariance with every other asset. Both sets of inputs, the expected return vector and the covariance matrix, has to be quantitative in nature. Typically, the expected returns are obtained by statistical regression models and often modified by an investment professional based upon qualitative concerns and experience, i.e. they are often based to some extent on human judgments rather than solely mathematical analysis. The covariance inputs are also derived from historical asset price information using standard statistical techniques and they too may be subject to judgmental alterations

Owing to the difference in methodology between the approaches for obtaining the two required inputs and the fact that the expected return on each asset and the covariance between the assets are in fact, related quantities, the two sets of inputs can be inconsistent with each other in the conventional approach, especially as many classes of assets are considered for allocation. This inconsistency between the two sets of inputs results in rather “extreme” asset allocations that experienced portfolio managers are generally not inclined to follow in their decision-making. For example, it is found that conventional asset allocation models generate portfolios in which some assets are sold short in large quantities, and other assets are purchased with the funds raised in the short sales. This type of allocation is typically highly leveraged and generally involves more risk than historical statistical analysis would indicate. To obtain more acceptable results, practitioners often modify the conventional techniques slightly by constraining allowable weights of assets or other types of constraints. These modified models usually produce a “corner” solution that hits one or more of the constraints and does not necessarily obtain the best allocation.

It is accordingly believed that there is a need for an improved method for asset allocation that is consistent with both the historical behavior of asset values and with the qualitative judgments of investment professionals and therefore generates proposals for asset allocation that are reliable, practical, and sensible.

### SUMMARY OF THE INVENTION

It is therefore an object of the present invention to provide a method for asset allocation that generates proposals for asset allocation that is consistent with both the historical behavior of asset values and with the qualitative judgments of investment professionals.

In view of this objective, the present invention provides a method for optimizing an allocation of a plurality of selected assets in which a set of discrete possible outcomes for returns on each of the plurality of assets are generated, and at least one favorable trade idea is provided. A subset of the discrete outcomes are identified as winning outcomes consistent with the at least one favorable trade idea and a remaining subset of discrete outcomes are identified as losing outcomes. After further constraints are specified, an allocation of the plurality of assets is determined that optimizes an attribute of at least one of the winning and losing outcomes subject to the further constraints.

### BRIEF DESCRIPTION OF THE DRAWINGS

FIG. 1 shows a schematic block diagram of an embodiment of an asset allocation optimization method according to the present invention.

FIG. 2 depicts an example graphical user interface adapted for the optimization method according to the present invention.

FIG. 3A is a histogram of the probability for levels of excess return for the optimized asset allocated using only “winning” outcomes.

FIG. 3B is a histogram of probability for levels of excess return for the optimized asset allocated using only “losing” outcomes.

### DETAILED DESCRIPTION

As used herein, an “asset” is any financial instrument or security such as a stock, bond, option, or derivative having a readily determinable market price.

A “favorable trade idea” is a qualitative prediction that one or more assets will produce a greater return over a certain period than another set of one or more assets. It can be expressed in the form of a purchase and a short sale. For example, if an portfolio manager expects that one unit of asset A will produce a greater return than 1.5 units of asset B, this can be expressed as A>1.5B or equivalently, A+(−1.5B)>0. In this case then, the purchase of one unit of A combined with the short sale of 1.5 units of B is considered to be a favorable trade idea.

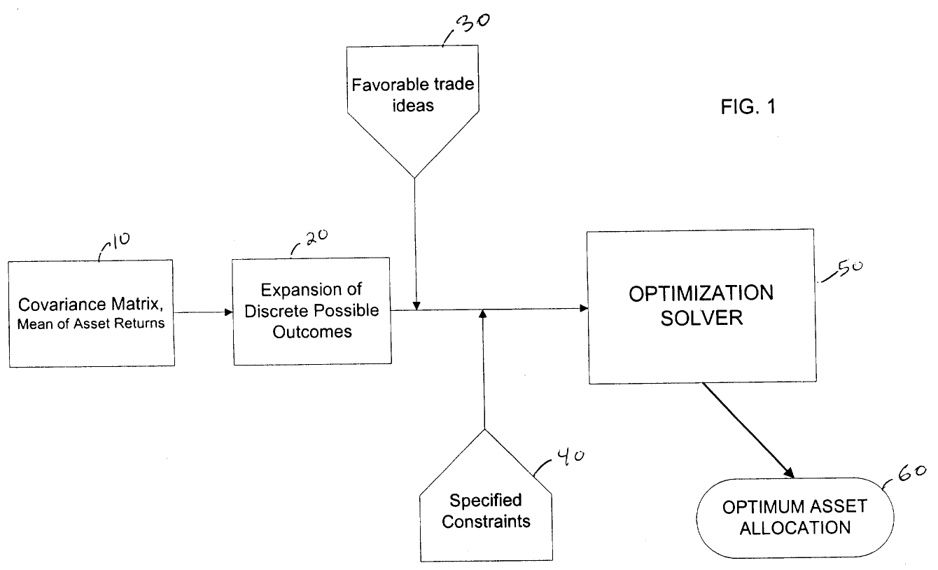

FIG. 1 shows a schematic block diagram of an embodiment of an asset allocation optimization method according to the present invention. As shown, a covariance matrix, and a mean return vector 10 of the different assets to be allocated are compiled and used as a data resource in the optimization process. The covariance matrix 10 is an n×n symmetric matrix, where n is the number of individual assets selected for allocation. The individual assets can be of a single class, such as equities, or can include a mix of classes such as stocks and bonds. The entries aᵢⱼ(=aⱼᵢ) within the matrix represent the covariance of the “ith” asset with respect to the “jth” asset where i,j≦n. The covariance between a pair of assets is a measure of both the degree of correlation between the returns on the assets, and also indicates the degree of volatility, i.e. variance. In other words, the covariance includes measures of correlation and standard deviation. The measurements are taken from historical and current data and represent fixed, quantitative information provided as an input to the optimization process.

The mean return vector refers to the average return from each asset class and may be readily observable in the financial markets. For example the yield on a government bond would be the average return from that bond until it matures. For currencies one could use the interest rate differential over the investment horizon as the mean return. When the mean is not readily observable for a particular asset then it can be obtained simply by averaging the returns over historical data. It is also worthwhile to distinguish between the mean return and the expected return as used in conventional optimization processes. The mean return is a statistic describing the average return from an asset that is either readily available in the market place or can be calculated by averaging returns over a long time horizon, whereas the expected return relates to the return in the current period as expected by the portfolio manager. For example a portfolio manager can expect 15% return from the 30 year US Treasury bond over the next year even though the yield of the bond is 5%. The difference would indicate that the portfolio manager is expecting the interest rates to go down over the next year, thereby appreciating the price of the bond.

In a more general setting one may use a general joint distribution function for all the asset returns in place of the covariance matrix. When the asset returns can be assumed to be normally distributed, the covariance matrix is a sufficient input to the optimum asset allocation process. It is understood that we hold to this assumption for ease of exposition and the invention can be modified to accommodate other possibilities including, but not limited to, the direct specification of the joint density function for the asset returns.

The covariance matrix 10 can be used to create an expansion of possible outcomes 20 for the values of the different assets in the matrix as will be explained further detail below. Favorable trade ideas 30 selected on a qualitative basis can then be used as a filter from which to identify a group of the total set of possible outcomes as “winning” outcomes, while marking the remainder of the possible outcomes as “losing” outcomes (the favored trade ideas may also be weighted with a weighting factor, as will be explained below). In addition to distinguishing between outcomes based on favored trade ideas, additional constraints 40 are specified such as, for example, a maximum permissible loss for all outcomes, or a maximum probability of a large loss (risk). The marked outcomes, constraints, and benchmark data are provided to an optimizer or solver program 50 which, according to one particular embodiment, computes weights 60, or relative percentages, of each of the assets that maximizes the return for the winning outcomes versus the benchmark while subject to the additional constraints specified. This “solution” is then output for review by the portfolio manager.

The following example illustrates, in simplified form, one technique that may be used to generate a discrete set (an “expansion”) of projected outcomes for the returns of each selected asset. It is noted that other techniques for generating an expansion of outcomes may also be used in accordance with the present invention. In this example, only two assets are selected, equities X and Y. The historical average covariance of X and Y has been determined to be 0.5. The variance of X and the variance of Y are both determined to be 1. Therefore, the covariance matrix for X and Y may be written as:

$$[ \begin{matrix}1 & .5 \\ .5 & 1\end{matrix} ]$$

From this covariance matrix, Cholesky decomposition is derived according to known matrix algebra techniques. The Cholestky decomposition is used to obtain orthogonalized factors, f1 and f2, which can be used as building blocks to generate mathematical expressions for asset values X and Y. Since the new varaibles f, and f₂ are orthogonal, they are not at all correlated with one another, so that they can be varied independently of each other. Expression (1) shows the Cholesky decomposition of X and Y in terms of f₁ and f₂ consistent with the covariance matrix:

$$X = {f}_{1}$$

$$Y = 0.5 {f}_{1} + \sqrt{\frac{3}{4}} {f}_{2}$$

where the variances of f₁ and f₂ are given as:

σ²(f₁)=1, and σ²(f₂)=1

Next we determine the mean of the each orthogonal factor based on the means of X and Y. For the purpose of illustration, let us assume that the mean of f₁ and f₂ are 4 and 2 respectively. Then the following expansion table can be generated by using the Cholesky decomposition:

TABLE I

| expansion of F1 | F1 | Expansion of F2 | F2 | X | Y |
|---|---|---|---|---|---|
| Add standard | 5 | Add standard | 3 | 5 | 5.098076 |
| deviation | | deviation | | | |
| Add standard | 5 | | 2 | 5 | 4.232051 |
| deviation | | | | | |
| Add standard | 5 | Subtract standard | 1 | 5 | 3.366025 |
| deviation | | deviation | | | |
| | 4 | Add standard | 3 | 4 | 4.598076 |
| | | deviation | | | |
| | 4 | | 2 | 4 | 3.732051 |
| | 4 | Subtract standard | 1 | 4 | 2.866025 |
| | | deviation | | | |
| Subtract standard | 3 | Add standard | 3 | 3 | 4.098076 |
| deviation | | deviation | | | |
| Subtract standard | 3 | | 2 | 3 | 3.232051 |
| deviation | | | | | |
| Subtract standard | 3 | Subtract standard | 1 | 3 | 2.366025 |
| deviation | | deviation | | | |

As can be discerned from Table I, each of the factors f₁ and f₂ is discretized into three possible values: the mean, the mean plus the standard deviation, and the mean minus the standard deviation. In this manner, there are 3×3 or 9 different pairs of outcomes for f₁ and f₂ and therefore also 9 possible outcomes of X and Y through the expressions for X and Y in terms of f₁ and f₂ (1) above. In general according to this technique, for a number n of assets and k possible values for each asset, kⁿ discrete outcomes are generated.

Once the possible outcomes derived from the covariance matrix have been traced out, the favorable trade ideas can be applied to mark certain combination of X and Y as “winning” outcomes. As one example, an portfolio manager may predict that a purchase of Y with a simultaneous short sale of X (of equal notional value) would be a favorable trade. In this case, each outcome for which the return on Y is greater than X is marked as a winning outcome, and each outcome where reverse occurs is marked as a losing outcome. Table II lists how the various outcomes of X and Y from Table I are marked:

TABLE II

| X | Y | OUTCOME |
|---|---|---|
| 5 | 5.098076 | Winning |
| 5 | 4.232051 | Losing |
| 5 | 3.366025 | Losing |
| 4 | 4.598076 | Winning |
| 4 | 3.732051 | Losing |
| 4 | 2.866025 | Losing |
| 3 | 4.098076 | Winning |
| 3 | 3.232051 | Winning |
| 3 | 2.366025 | Losing |

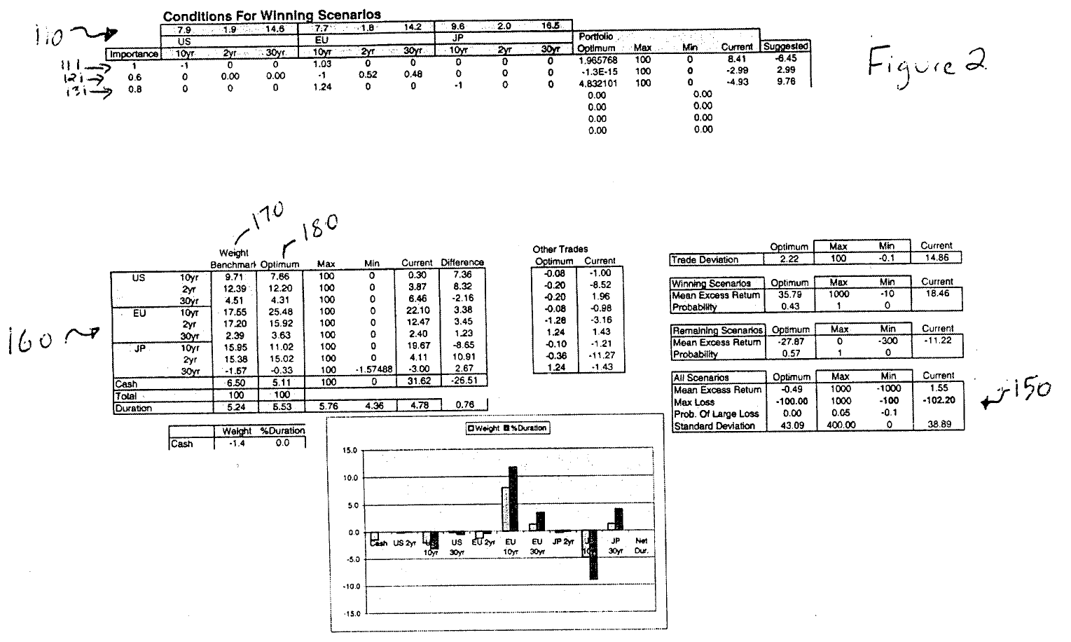

Thus, in this example, there are four winning outcomes and five losing outcomes. It is noted that typical asset allocations will involve more than two assets, and more than one favorable trade idea. In that case, each favorable trade idea is associated with a weighting factor so that a final determination can be made as to whether a given outcome is a “winning” or “losing” scenario. As can be discerned in FIG. 2, which depicts a graphical user interface 100 for an optimization program according to the present invention, a top section 110 labeled as “Conditions for Winning Scenarios” lists three different favorable trade ideas 111, 121, 131 in the rows of the section. Favorable trade idea 111 calls for a short sale of one unit of a US 10-year bond with a purchase of 1.03 units of a European Union 10-year bond; the second favorable trade idea 112 calls for a short sale of one unit of a European Union 10-year bond with purchases 0.52 units of a European Union 2-year bond and 0.48 units of a European Union 30-year bond; and the third favorable trade idea 13 calls for a purchase of 1.24 units of a European Union 10-year bond and a short sale of one unit of a Japanese 10-year bond. The first column of each of the favorable trade ideas 111, 121, 131 is labeled “Importance” and includes the weighting factor for each of the three trades of 1, 0.6, and 0.8, respectively. For a given distribution of discrete outcomes for each of assets, the amount of gain for each trade is calculated, and then the gain on each trade is multiplied by the respective weighting factor. This is then summed to determine whether there is a final winning or losing outcome. An example of how a single outcome of projected asset returns is marked in light of multiple favorable trade ideas is shown in Table III as follows:

TABLE III

| | | | | | | | | Trade 1* | Trade 2* | Trade 3* | |
|---|---|---|---|---|---|---|---|---|---|---|---|
| US 10 yr | EU 10 yr | EU 2 yr | EU 30 yr | JP 10 yr | Trade 1 | Trade 2 | Trade 3 | weight | weight | weight | SUM |
| 0.2 | 0.1 | 0.2 | 0.1 | 0.05 | −0.097 | 0.052 | 0.074 | −0.097 | 0.0312 | 0.0592 | −0.0066 |

As can be discerned, the sum of the weighted trades for the specific outcome listed is negative, which indicates that the outcome has a negative total return is a “losing” outcome overall. Similar sum calculations are made for all other outcomes in the process of distinguishing between winning and losing outcomes.

Once the entire set of outcomes for the asset returns is marked, other specific constraints are input. The constraints area 150 shown in FIG. 2 lists various constraint parameters such as the mean return over the maximum loss 152 for all outcomes, and the probability of a large loss 154, and the standard deviation in different rows. Each row includes a input area 160 where an operator may enter or modify the values of these various constraints. For example, the value in the input box for the maximum allowable loss 154 is shown as −100, indicating that the optimizer will discard solutions for asset weights that have a maximum loss of greater than 100 for any outcome scenario. If the operator/portfolio manager determines that a greater degree of risk is tolerable, the maximum loss can be set at lower number such as −200. As the skilled practitioner will realize, adjustments to any of the constraints can affect the resulting solutions for asset weights in a manner that can be difficult to predict ahead of time, and one of main advantages of using an optimization program is that the solution produced is necessarily consistent with the selected values of the constraints.

The optimizer itself can employ one or more linear or non-linear optimization techniques known to those skilled in the art and widely available through software packages such as Microsoft Excel®. According to one implementation of the present invention, the optimizer determines the allocation of selected assets that maximizes the excess return (over a benchmark allocation of the same assets) of the assets over the entire group of “winning” outcomes previously generated. In this manner, the qualitative inputs regarding the favorable trade ideas determine the solution, because only those outcomes which that reflect the assumptions of the portfolio managers are used in calculation of the excess return. However, as noted above, the “losing” outcomes may also be taken into account in determining whether an allocation violates any of the stipulated constraints. Thus, while portfolio managers may wish to determine a solution that yields maximal return in accordance with their own assumptions, they might still wish to calculate the maximal loss or risk of the same solution without regard to their assumptions. The optimal asset weights determined by the optimizer are shown in the solution area 160 of FIG. 2 at column 180 next to a benchmark allocation 170 of the same assets. As can be discerned, the various optimum weights shown can differ substantially from the benchmark weights, but still remain within an acceptable and practical range, and moreover, do not call for a high amount of leveraging.

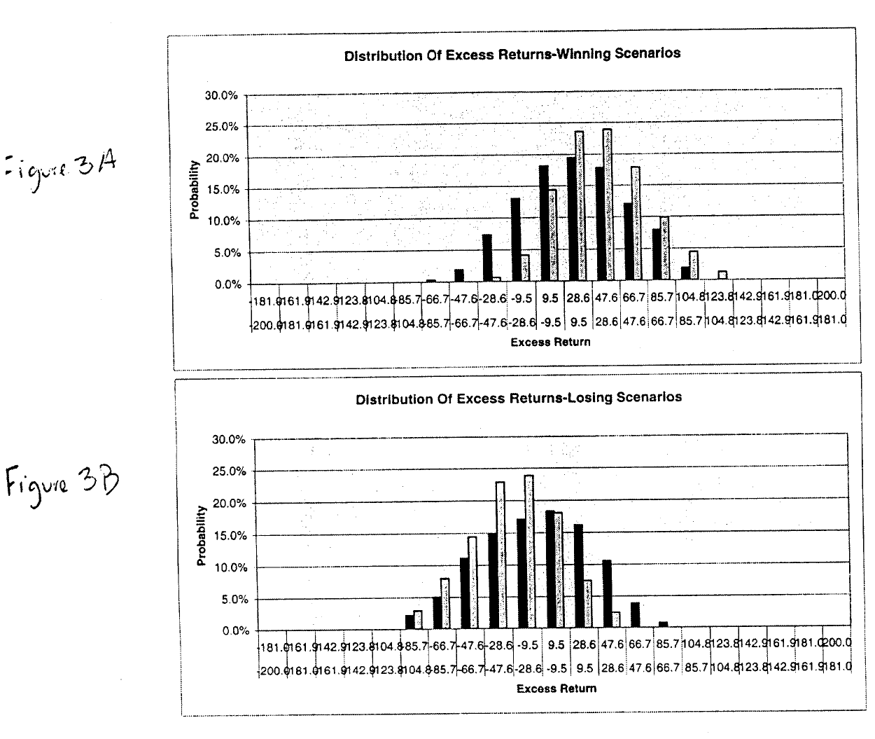

FIG. 3A is a histogram showing the probability for levels of excess return for the optimized asset allocation using only winning outcomes. FIG. 3B is a histogram showing the probability for levels of excess return for the optimized asset allocated using only losing outcomes. As can be discerned by comparing the histogram of FIG. 3A to FIG. 3B, the mean excess return level is higher (shifted to the right) for the winning outcomes in FIG. 3A than for the losing outcomes in FIG. 3B. This is to be expected since the asset allocation reflected in FIGS. 3A and 3B was optimized to maximize the mean excess return of only the winning outcomes.

It is noted that the optimization criteria and constraints discussed above are merely exemplary, and that the optimizer can be used to maximize or minimize other parameters, subject to other or additional constraints. For example, rather than optimizing to maximize the excess return for winning outcomes, the optimizer may be preset to minimize the risk of the losing outcomes, and a minimum excess return for the winning outcomes can be used in this alternative case as a constraint rather than the optimized variable. Additionally, the mean excess return on either the winning or losing outcomes can itself be used as a constraint instead of an optimized variable. The following list includes some of the interesting variables that can be seek to be maximized or minimized under the current invention:

Maximizing the mean of the portfolio return under the winning outcomes

Minimizing the mean of the of the portfolio return under the losing outcomes

Maximizing the probability of a win greater than a pre-specified level under the winning outcomes

Minimizing the probability of a loss lower than a pre-specified level under the losing outcomes

Minimizing the standard deviation of the portfolio return under the winning and losing outcomes combined

Minimizing the mean of the square loss under the losing outcomes

In the foregoing description, the method of the present invention has been described with reference to a number of examples that are not to be considered limiting. Rather, it is to be understood and expected that variations in the principles of the method and apparatus herein disclosed may be made by one skilled in the art and it is intended that such modifications, changes, and/or substitutions are to be included within the scope of the present invention as set forth in the appended claims. Furthermore, while the processes described can be implemented using a computer processor, the invention is not necessarily limited thereby, and the programmed logic that implements the processes can be separately embodied and stored on a storage medium, such as read-only-memory (ROM) readable by a general or special purpose programmable computer, for configuring the computer when the storage medium is read by the computer to perform the functions described above.

What is claimed is:

1. A method for optimizing an allocation of a plurality of selected assets comprising:
generating a set of discrete possible outcomes for returns on each of the plurality of assets;
providing at least one favorable trade idea;
identifying a subset of the discrete outcomes as winning outcomes consistent with the at least one favorable trade idea and a remaining subset of discrete outcomes as losing outcomes;
specifying further constraints; and
determining the allocation of the plurality of assets that optimizes an attribute of at least one of the winning and losing outcomes subject to the further constraints.

2. The method of claim 1, wherein the attribute that is optimized is a maximal return for the winning outcomes.

3. The method of claim 1, wherein the attribute that is optimized is a minimal maximum loss for all of the outcomes.

4. The method of claim 1, wherein the attribute that is optimized is a minimal probability of loss exceeding a specified value for all of the outcomes.

5. The method of claim 1, wherein the attribute that is optimized is a minimal standard deviation of returns for all of the outcomes

6. The method of claim 1, wherein the attribute that is optimized is a minimal average loss for the losing outcomes

7. The method of claim 1, further comprising:
providing historical and current data for each of the plurality of assets;
wherein the data is used in generating the set of discrete possible outcomes for the returns on each of the plurality of assets.

8. The method of claim 7, further comprising:
generating a covariance matrix from the historical data; and
deriving an orthogonal decomposition including orthogonal factors from the covariance matrix;
wherein the returns of the plurality of assets are expressed in terms of the orthogonal factors.

9. The method of claim 8, further comprising:
deriving the orthogonal factors from a Cholesky or Jordan Canonical Decomposition of the covariance matrix

10. The method of claim 1, wherein the specified constraints include at least one of a maximum loss for all outcomes, a maximum standard deviation for all outcomes, a maximum probability of a large loss for all outcomes, and a minimum mean excess return for the winning outcomes.

11. The method of claim 1, further comprising:
if the at least one favorable trade idea includes two or more favorable trade ideas, providing a weighting factor for each of the favorable trade ideas.

12. An article comprising a computer-readable medium which stores computer-executable instructions for causing a computer to optimize an allocation of a plurality of selected assets by performing the steps of:
generating a set of discrete possible outcomes for returns on each of the plurality of assets;
receiving at least one favorable trade idea;
identifying a subset of the discrete outcomes as “winning” outcomes consistent with the at least one favorable trade idea and a remaining subset of discrete outcomes as “losing” outcomes;
receiving specified further constraints; and
determining the allocation of the plurality of assets that optimizes an attribute of at least one of the winning and losing outcomes subject to the further constraints.

13. The article of claim 12, further storing instructions for causing a computer to perform the steps of:
receiving historical and current data for each of the plurality of assets; and
generating the set of discrete possible outcomes for the returns on each of the plurality of assets from the data.

14. The article of claim 13, further storing instructions for causing a computer to perform the steps of:
generating a covariance matrix from the historical data; and
deriving orthogonal factors from the covariance matrix;
wherein the returns of the plurality of assets are expressed in terms of the orthogonal factors.
